(19) United States
(12) Patent Application Publication
(10) Pub. No.: US 2011/0134082 A1
(43) Pub. Date: Jun. 9, 2011

(54) INFORMATION INPUT SYSTEM, METHOD FOR INPUTTING INFORMATION AND INFORMATION INPUT PROGRAM

(76) Inventors: Hideo Mitsuhashi, Tokyo (JP); Shin Norieda, Tokyo (JP)

(21) Appl. No.: 13/057,369

(22) PCT Filed: Jun. 25, 2009
(86) PCT No.: PCT/JP2009/061607

§ 371 Date: Feb. 3, 2011

(30) Foreign Application Priority Data
Aug. 29, 2008 (JP) 2008-222931

(51) Int. Cl. G06F 3/043

(52) U.S. Cl. 345/177

(57) ABSTRACT

Provided is an information input system, wherein an operator can easily conduct information input actions to a small information device. The information input system is provided with a vibration element that applies a vibration to a forefinger of an operator, a vibration sensor that measures the vibration transmitted through the forefinger and the thumb, and a first input information specifying module that specifies the position on the thumb where another finger of the operator is in contact with the thumb based on a change in transmission property of the transmission system caused by the fact that the finger of the operator, which is in contact with the thumb, is in contact with the vibration transmission system formed by including the forefinger and the thumb. The information input system outputs the detected position of the contact of the finger as positional information.

### TECHNICAL FIELD

The present invention relates to an information input system, an information input method, and an information input program in mobile devices such as mobile phones, PDAs, and notebook PCs.

### BACKGROUND ART

For the mobile devices such as mobile phones, PDAs, and notebook PCs, desired is the portability-oriented and easy-to-see mobile devices having a still larger display unit such as a display. Thus, there is a demand for a mobile device with a still smaller input unit provided (hereon.

For that, as a related technique for reducing the key layout space of the input unit on the mobile device, there is considered a function which allots a plurality of functions to a single input. As an example thereof, disclosed is a method which places a joystick on the device for detecting tilt angles of top-and-bottom as well as left-and-right directions, and switches characters according to the tilt directions (see Patent Document 1).

Further, as another related technique, there is a method which separates an input detection unit from a device and places it independently. As such related technique, there is a device which executes input operations by having the detection unit loaded on the body of a user (see Patent Document 2).

Further, as a method for reducing the space of the input unit for detecting actions of the operator made on the device, there is a method which performs handwriting character input operations by detecting digital compressions in X-, Y-, and Z-axial directions. As an example thereof, disclosed is a technique which uses track points to perform handwriting character input operations according to change patterns of the digital compression (see Patent Document 3).

Further, as another related technique, disclosed is a method which picks up characters written on a handwriting paper by a digital camera, and specifies contact positions of a handwriting input pen by using an infrared camera which picks up light emitting paths in a time series manner and transforms those to electric signals (see Patent Document 4).

Further, as another related technique, disclosed is a method which applies electricity to an object by voltages on all X lines of a sensor matrix, measures the electric amount transmitted through the object by a position sensing transducer constituted with a touch sensitive surface disposed on a substrate, and specifies the positions of an object (another object) based on a change in the capacitance of a conductor generated due to an approach of the object (see Patent Document 5).
Patent Document 1: Japanese Unexamined Patent Publication 2005-258734
Patent Document 2: Japanese Patent Application Publication 2004-537802
Patent Document 3: Japanese Unexamined Patent Publication 2005-301874
Patent Document 4: Japanese Unexamined Patent Publication Hei 10-124178
Patent Document 5: Japanese Patent Application Publication Hei 10-505183

### DISCLOSURE OF THE INVENTION

### Problems to be Solved by the Invention

However, with the related technique disclosed in Patent Document 1 described above, it is necessary to get accustomed to the way of input since the tilt directions of the joystick for conducting each input operation are different from those of an input method of a mobile device. Furthermore, the input operation becomes complicated, so that input errors are to be increased.

Further, with the related technique disclosed in Patent Document 2 described above, it is necessary to prepare the input unit separately from the mobile device, so that the portability thereof becomes poor. Furthermore, the operator is required to go through a troublesome work of wearing the detection unit.

Further, considering the related information disclosed in Patent Document 3 described above, it is difficult to check the actions since there is no shift of the fingertip that conducts the input action. Thus, input errors are to be increased.

Furthermore, the related information depicted in Patent Document 4 described above is a structure which utilizes characters written on a paper for input, so that it cannot be applied to small information devices where the region and space for conducting input operations are limited.

Further, the related information depicted in Patent Document 5 described above is a structure having a sensor matrix array for input operations, so that it cannot be applied to small information devices where the region and space for conducting input operations are limited.

It is an object of the present invention to provide an information input system, an information input method, and an information input program with which the inconveniences of the related techniques described above can be improved and the operator can easily conduct information input actions to a small information device.

### Means for Solving the Problems

In order to achieve the foregoing object, the information input system according to the present invention is characterized to include: a physical amount applying module which applies a specific physical amount to a signal transmitting object; a transmitted physical amount measuring module which measures the physical amount transmitted via the object; and a contact position specifying module which detects a change in a transmission property generated when another object touches a transmission system of the physical amount formed by including the object, wherein the contact position specifying module specifies a contact position of the object based on a measurement signal of the physical amount transformed by corresponding to the change in the transmission property, and outputs positional information of the specified contact position.

Further, the information input method according to the present invention is characterized to include: applying a specific physical amount to a signal transmitting object; measuring the physical amount transmitted via the object; specifying a contact position of another object based on a change in a transmission property of a transmission system generated when another object mentioned above touches the transmission system of the physical amount formed by including the object; and outputting the specified contact position of another object mentioned above as positional information.

Furthermore, the information input program according to the present invention is an information input program for applying a specific physical amount transmitted via an object, to the object, measuring the physical amount transmitted via the object, and outputting information specified based on a change in a result of the measurement, and the program is characterized to cause a computer set in advance to execute: a contact position specifying function which specifies a contact position of another object based on a change in a transmission property of a transmission system generated when another object mentioned above touches the transmission system of the physical amount formed by including the object.

### Effect of the Invention

The present invention is structured and functions in the manner described above. According to that, the present invention is structured to include the physical amount applying module which applies a specific physical amount to an object, the transmitted physical amount measuring module which measures the physical amount transmitted via the object, and the contact position specifying module which specifies the contact position of another object based on a change in a transmission property of the transmission system generated when another object mentioned above touches the transmission system of the physical amount formed by including the object, and structured to output the specified contact position of the another object mentioned above as positional information.

Therefore, it is possible to provide the information input system, the information input method, and the information input program with which the operator can conduct information input actions easily to the small information device where the space for input operations is limited.

### BRIEF DESCRIPTION OF THE DRAWINGS

FIG. 1 is a schematic block diagram showing an exemplary embodiment of an information input system according to the present invention;

FIG. 2 is a flowchart showing processing action steps of the information input system disclosed in FIG. 1;

FIG. 3 is a schematic explanatory illustration showing an example of a character input method employed in the information input system disclosed in FIG. 1;

FIG. 4 is a schematic block diagram showing an exemplary embodiment of the information input system according to the present invention; and

FIG. 5 is a flowchart showing processing action steps of the information input system disclosed in FIG. 4.

### BEST MODES FOR CARRYING OUT THE INVENTION

### First Exemplary Embodiment

Next, basic structural contents of exemplary embodiments of the invention will be described.

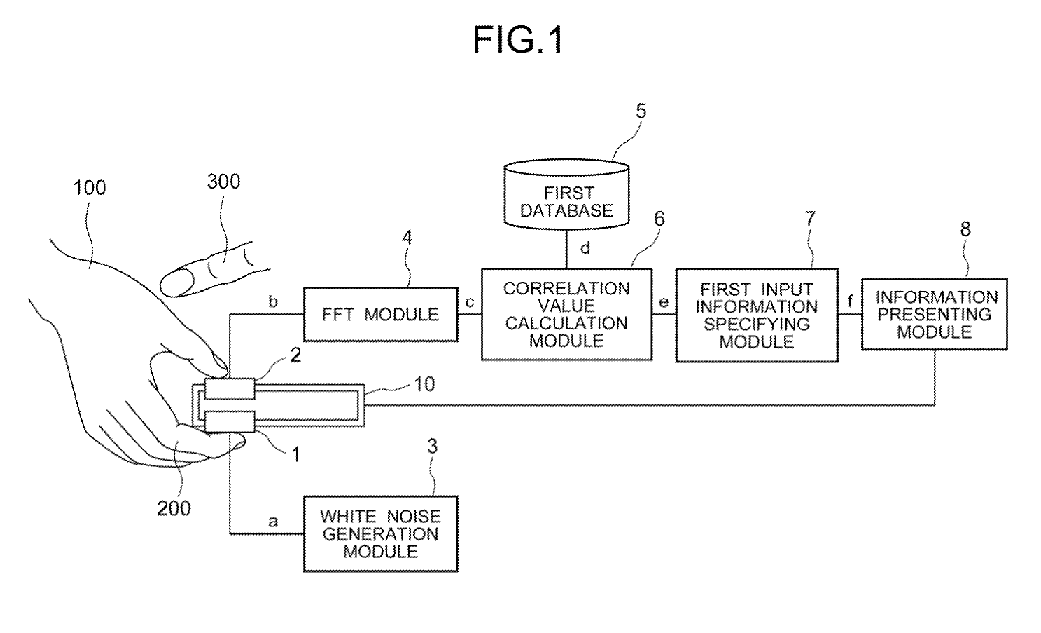

As shown in FIG. 1, an information input system of the exemplary embodiment is placed as an input unit (information input system) of a casing 10 as a mobile device main body unit such as a mobile phone, a PDA, or a notebook PC, and the information input system includes: a vibration element (corresponding to a physical amount applying module) 1 as a vibration generating source; a white noise generation module 3 which is connected to the vibration element 1 and outputs a drive signal a to generate a vibration constituted with a plurality of mixed frequencies in the vibration element 1; and a vibration sensor (corresponding to a transmitted physical amount measuring module) 2 which detects the vibration.

Further, the exemplary embodiment is designed to include: an FFT (Fast Fourier Transform) module 4 which is connected to the vibration sensor 2 and performs fast Fourier transform processing on a vibration detection signal b outputted from the vibration sensor 2, and outputs it as a frequency axis signal c; and a first database 5 which stores in advance reference waveform data d as a plurality of frequency axis signal waveforms corresponding to a plurality of input positions.

Further, the exemplary embodiment is structured by including: a correlation value calculation module 6 which receives the frequency axis signal c and a plurality of pieces of reference waveform data d, calculates the correlation values between the frequency axis signal c and the plurality of pieces of reference waveform data d, and outputs the values as a plurality of pieces of correlation value data e; a first input information specifying module (corresponding to a contact position specifying module) 7 which receives the plurality of pieces of correlation value data e, specifies the input position that corresponds to the reference waveform data d showing the highest correlation value as the actual input position, and outputs the input position as input position specifying data f; and an information presenting module 8 which outputs/displays prescribed symbol, data, and functional information allotted to that position on a display unit such as a display provided in advance to the casing 10 upon receiving the input position specifying data f.

While the white noise generation module 3, the FFT module 4, the first database 5, the correlation value calculation module 6, the first input information specifying module 7, and the information presenting module 8 are illustrated outside the casing 10 in the drawing for the conveniences' sake, it is to be noted that all of those modules are placed inside the casing 10.

Further, the casing 10 includes a CPU (Central Processing Unit), a memory, other storage units, and the like within the casing 10, and the operation functions of each of the modules are achieved through controlling and executing preset programs loaded inside the memory by the CPU.

Further, with this exemplary embodiment, a thumb 100 of an operator is used as an input area. Specifically, information input operations corresponding to each of the contact positions are conducted by touching a plurality of positions set on the thumb 100 of the operator by another finger 300 of the operator.

Thus, in the above-described structure, the vibration element 1 is disposed on the surface of the casing 10 that is the mobile device to be in contact with a forefinger 200 of the operator, and the vibration sensor 2 is disposed on the surface of the casing 10 to be in contact with the thumb 100 of the operator.

Thereby, with this exemplary embodiment, the input area where the operator conducts the input operations to the mobile device can be set on the finger of the operator oneself. Therefore, the input area can be set large, so that the operator can easily execute input operations to the mobile device, such as selection and finalization operations.

It is desirable to isolate the vibration element 1 and the vibration sensor 2 so that the vibration does not transmit inside the casing 10.

Further, as a method for the isolation, it is possible to employ typical vibration blocking methods, e.g., placing an anti-vibration member between the vibration element 1 and the vibration sensor 2, or providing a space between the vibration element 1 and the vibration sensor 2.

Further, in a case where those cannot be isolated, it is possible to take the vibration detection signal b as a signal that has transmitted only the finger of the operator through recording in advance a vibration that is detected by the vibration sensor 2 in a state where the forefinger 200 and the thumb 100 are not in contact, i.e., a vibration that does not transmit the finger of the operator but transmits only the casing 10, and subtracting that vibration from the vibration detection signal b outputted by the vibration sensor 2 at the time of operation.

Further, in addition to the case of recording the vibration in advance, it is possible to place another vibration sensor at a position in the vicinity of the vibration sensor 2 where the finger of the operator does not make a contact, and use the detection signal thereof as the signal subtracted from the vibration detection signal b. Since the finger of the operator is not in contact with this vibration sensor, the detection signal is the vibration that does not transmit the finger of the operator but transmits only the casing 10.

Further, the reference waveform data d is a pre-recorded data of the waveforms of the frequency axis signals c acquired respectively when another finger 300 of the operator touches the plurality of positions on the thumb 100 of the operator as input operations. As the vibration element 1 and the vibration sensor 2, piezoelectric elements or the like can be used.

### (Explanations Regarding Actions of First Exemplary Embodiment)

Next, actions of the information input system according to the first exemplary embodiment will be described briefly.

First, a vibration (corresponding to a physical amount) is applied to the fingers (the forefinger 200 and the thumb 100: corresponding to the objects) of the operator, and the vibration transmitted via the fingers of the operator is measured. Then, the contact position in the thumb 100 touched by another finger (another finger 300 of the operator touching the thumb) of the operator is specified based on a change in the transmission property of a transmission system generated by the contact of another finger of the operator made on the vibration transmission system formed by including the fingers of the operator, and the specified contact position is outputted as positional information.

Regarding the contact position specifying function which specifies the contact position in the thumb 100 made by another finger (another finger 300 of the operator touching the thumb) of the operator based on a change in the transmission property of the transmission system generated by the contact of another finger of the operator made on the vibration transmission system formed by including the fingers of the operator, it is also possible to put the operation contents into a program to be automatically executed by a computer that is provided in advance inside a mobile terminal (the casing 10).

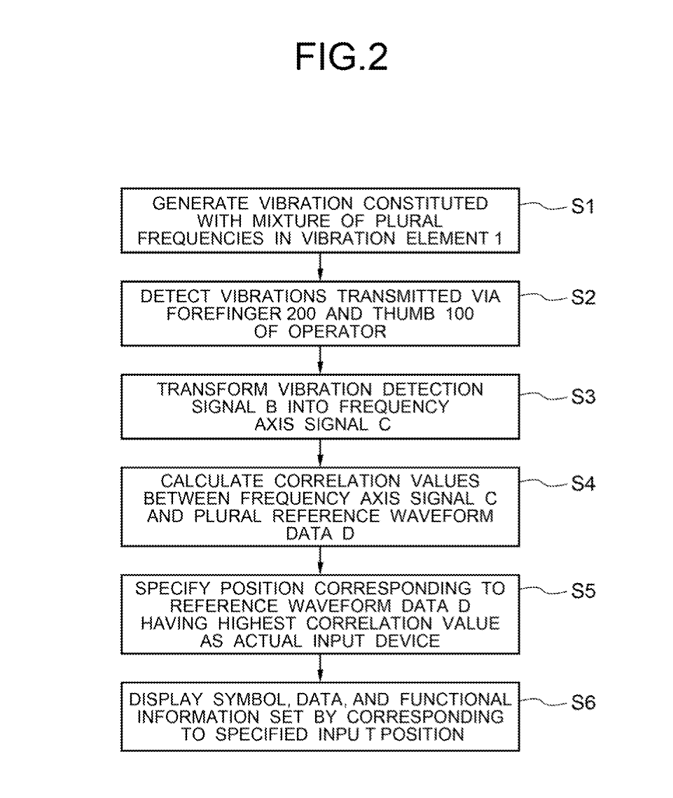

Next, actions of the information input system according to the first exemplary embodiment will be described in details based on a flowchart shown in FIG. 2.

First, the white noise generation module 3 outputs the drive signal a to the vibration element 1 to generate a vibration constituted with a plurality of mixed frequencies in the vibration element 1 (step S1).

Then, the vibration generated in the vibration element 1 transmits through the forefinger 200 of the operator that is in contact with the vibration element 1 and further transmits through the thumb 100, which is detected by the vibration sensor 2 and outputted as the vibration detection signal b (step S2).

This vibration detection signal b turns out as a vibration waveform that is different from the vibration waveform generated by the vibration element 1 due to an influence of the vibration transmission properties of the forefinger 200 and the thumb 100 of the operator.

Provided that the signal waveform on a frequency axis of the vibration waveform generated by the vibration element 1 is U(s), the signal waveform on the frequency axis of the vibration detection signal b detected by the vibration sensor 2 is Y(s), and the so-called transmission function that is the vibration transmission properties of the forefinger 200 and the thumb 100 of the operator on the frequency axis is G(s), relations regarding each of those can be expressed by [Expression 1] shown below.

Y(s)=G(s)×U(s) [Expression 1]

On that condition, when another finger 300 touches a prescribed position on the thumb 100 of the operator, the vibration transmission property changes. Therefore, the transmission function G(s) changes, and Y(s) changes as a result.

For example, when a position of pressing a vibrating string is changed, a vibration mode of the string changes and the vibration transmission property becomes changed. Similarly, through making another finger touch a prescribed position on the thumb of the operator, the transmission function of the vibration changes and the vibration waveform detected by the vibration sensor changes with respect to the vibration (the vibration transmission property) transmitted to the vibration sensor via the forefinger and the thumb of the operator.

Further, as in the case where the vibration mode of the string changes depending on the positions of pressing the string, the transmission function G(s) of different vibration waveforms from each other is to be detected by the detection sensor when the positions on the thumb 100 to be touched by another finger 300 vary. Thereby, Y(s) becomes different as well.

Therefore, it is possible to specify at which position on the thumb 100 another finger 300 has touched through recognizing (detecting) the difference in the detected signal waveform Y(s). As described above, the vibration element 1 generates a vibration constituted with a plurality of mixed frequencies (white noise) for the forefinger 200. Thus, when another finger 300 touches on the thumb 100, a signal of high periodicity that is prominently different from the white noise is detected by the vibration sensor 2. Thereby, the vibration sensor 2 can clearly detect a contact of another finger 300 made on the thumb 100 as a waveform change (change in the transmission function G(s)) in the vibration detection signal b.

Then, the FFT module 4 performs fast Fourier transform processing on the vibration detection signal b outputted from the vibration sensor 2 to transform it to the frequency axis signal c, i.e., Y(s) (step S3). Then, the correlation value calculation module 6 respectively calculates correlation values with respect to the reference waveform data d that is Y(s) corresponding to a plurality of input positions recorded in advance in the first database 5 (step S4).

The reference waveform data d is the data acquired by setting three contact positions on the thumb 100, for example, which are values of Y(s) recorded as Y1(s), Y2(s), and Y3(s) acquired when another finger 300 touches the respective positions. This recording work may be executed by the operator as an initial setting or may be done at the time of manufacture by using an average value or the like of data of a plurality of operators.

The waveform of the frequency axis signal c outputted from the FFT module 4 becomes close to one of the forms of the plurality of pieces of reference waveform data d, i.e., Y1(s), Y2(s), or Y3(s), depending on the contact positions on the thumb 100. Thus, the position corresponding to the reference waveform data d showing the largest correlation value among the correlation values between the frequency signal c and the plurality of pieces of reference waveform data d is the actual contact position.

Therefore, the first input information specifying module 7 specifies the input position corresponding to the reference waveform data d showing the highest correlation value among the plurality of pieces of correlation value data e as an actual input position, and outputs the position as input information specifying data f (step S5). At last, prescribed symbol, data, and function allotted to the specified position are displayed on the information presenting module 8 (step S6), and the input operation is completed thereby.

The reason that the vibration generated by the vibration element 1 is defined to be a mixture of a plurality of frequencies in this exemplary embodiment is to make Y1(s), Y2(s), and Y3(s) be in frequency axis signal waveforms of different shapes from each other. Thus, the number and period of the mixed vibration frequencies are not limited to any specific values as long as Y1(s), Y2(s), and Y3(s) can be selected in a manner identifiable from each other.

Further, while the contact position is detected with the frequency axis waveform in the above (explanation of the actions), the position specifying action may also be executed while keeping a form of time axis signals as long as those are the vibration frequencies with which there are feature changes depending on the contact positions, since it only needs to be able to recognize the difference in the vibration detection signal b generated due to the difference in the transmission function G(s) in this exemplary embodiment.

Furthermore, the correlation values between the frequency signal c and the plurality of pieces of accumulated data d are calculated in the explanations of the actions of the first exemplary embodiment. However, provided that there are two vibration frequencies f1 and f2, for example, whose relation regarding their values and the way of changes vary depending on the three contact positions, it is also possible to specify the contact position not by calculating the correlation values but based on the relation between the vibration frequencies f1 and f2 or whether or not there is a change.

Further, it is also possible to perform detections such as tracing actions through detecting a time change in the contact position by repeatedly executing the above-described action.

Furthermore, through placing four vibration sensors 2 described above, it is possible to constitute so-called the ten-key input device that is loaded in a mobile phone, for example.

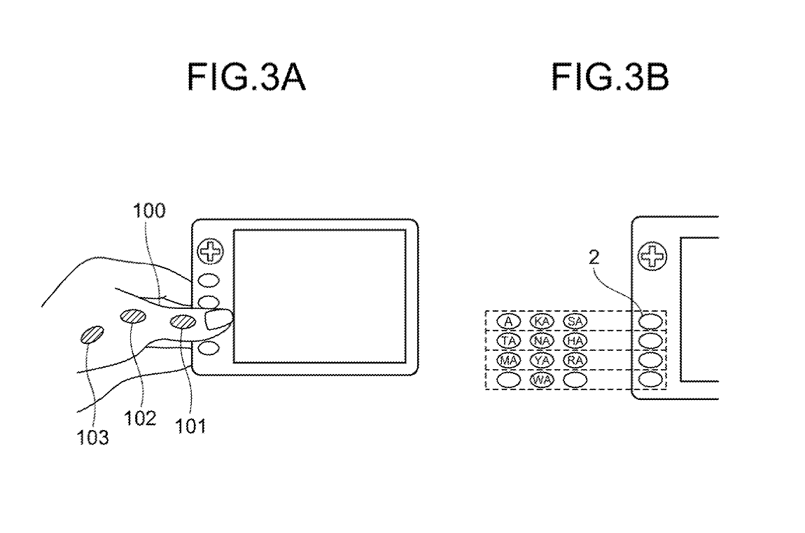

Now, a case of employing the information input system according to the present invention into a card-type terminal is illustrated in FIG. 3A and FIG. 3B.

In the card-type mobile terminal shown herein, an input unit (a ten-key input device) constituted with four vibration sensors 2 is placed on the outer surface thereof.

Hereinafter, this will be described in details.

As shown in FIG. 3A, four vibration sensors 2 are disposed on the casing 10, and different input keys from each other are allotted to three points of a first area 101, a second area 102, and a third area 103 on the thumb 100.

With this structure, input operations of 3×4=12 (kinds) as a typical ten-key input device can be achieved through moving the thumb 100 to be in contact with each of the four vibration sensors 2 and using three points on the thumb 100 as the input keys.

Explanations will be provided herein by being corresponded to key layout of a typical ten-key input device loaded on a mobile phone.

For example, regarding the four vibration sensors 2, when the thumb 100 touches the upper-most side vibration sensor 2 in FIG. 3B and another finger 300 touches the first area 101, the vibration sensor 2 functions as a key corresponding to a consonant “so” of input characters. Further, at this time, when the second area 102 in the thumb 100 is touched, the vibration sensor 2 functions as a key for inputting “ka”. Furthermore, when the third area 103 is touched, the vibration sensor 2 functions as a key for inputting “a”.

Further, in a case where another finger 300 touches the first area 101 while the thumb 100 is in contact with the second vibration sensor 2 from the upper side of FIG. 3B, the vibration sensor 2 functions as a key for inputting a consonant “ha”. In a case where another finger 300 touches the second area 102, the vibration sensor 2 functions as a key for inputting a consonant “na”. In a case where another finger 300 touches the third area 103, the vibration sensor 2 functions as a key for inputting a consonant “ta”.

Furthermore, in a state where the thumb 100 is in contact with the third vibration sensor 2 from the upper side of FIG. 3B, the vibration sensors function as keys for inputting “ra”, “ya”, and “ma” in the same manner as described above. Moreover, when the second area 102 is touched while the thumb 100 is in contact with the fourth vibration sensor 2 from the upper side of FIG. 3, the vibration sensor functions as a key for inputting a consonant “wa”.

Through continuously conducting input operations on the set input keys, the same input operations as the character input operations using the ten keys in the mobile phone can be executed. It is assumed that “ha”, “hi”, “hu”, “he”, and “ho”, as “ha” row can be inputted through continuously touching the first area 101 of the thumb 100 that is in contact with the second vibration sensor 2 from the upper side by another finger 300, for example. Further, regarding the combinations with the other input areas (the first to third areas) and the vibration sensors (the first to fourth), the input operations can be done in the same manner.

This makes it possible to form the input keys that are capable of achieving the same ten-key input operations as the case of the mobile phone through changing the positions of the vibration sensors 2 (the first to fourth sensors in this case) to which the thumb 100 makes contact even it is in the same input area on the thumb 100.

In the case of the above-described structure, it is necessary to detect which vibration sensor 2 among the four vibration sensors the thumb 100 is touching. Since the vibration is not detected by the vibration sensor 2 to which the thumb 100 is not in contact, the vibration sensor 2 having the output signal of the largest amplitude among the output signals from the four vibration sensors 2 may be detected as the vibration sensor 2 to which the thumb 100 is in contact.

Further, the numbers of the vibration sensors 2 and the input areas on the thumb 100 are not limited to the respective numbers defined in the above-described exemplary embodiment. Furthermore, the contact position of the thumb 100 may be detected by placing a contact sensor and the like using a static capacitance over the vibration sensor 2, for example.

Note here that there is one vibration element 1 disposed on the casing 10 on the back face of the side where the vibration sensors 2 are placed. It is not necessary to move the forefinger 200 side for the input operations described above, so that it is sufficient to place only one vibration element 1.

As described above, with the first exemplary embodiment of the information input system according to the present invention, the input positions (101, 102, 103) in the thumb 100 can be specified by using the finger (the thumb 100) of the operator as the input areas based on the change in the transmission function of the vibration transmitting through the finger. Thereby, in the mobile device having this information input system as an input user interface, the operator can achieve input operations for the mobile device by touching the finger (the thumb) by another finger. With this exemplary embodiment, the vibration element 1 and the vibration sensors 2 are only required to be provided as the input unit (input areas) set on the mobile device. Thus, it is possible to set a small input unit provided on the mobile device main body.

Further, with the exemplary embodiment, the detection unit for detecting input operations made by the operator is placed only on the device side. Thus, it is possible with the information input system of the present invention to achieve the mobile device with an excellent portability with which the detection unit for detecting the input operations does not need to be loaded on (worn by) the body of the user.

Further, compared to the case where the mobile device includes the input areas on the mobile device main body and the size thereof is formed small, it is possible with the exemplary embodiment to acquire a sufficiently large input area. Therefore, each function corresponding to the input operations made in the input areas is not set to correspond to the order of operations and combination but can be allotted to each input area. As a result, input errors made by the operator can be reduced and, further, the operator can shorten the time spent for input operations.

Further, compared to an input method used in a mobile device, which tilts a stick set on the mobile device main body and conducts pointing actions or the like according to the tilt angles, the information input system of the present invention is capable of reflecting the moving speed and moving amount of the pointer upon the operation speed and the operation moving amount. Thus, a delicate operation can be quickly done on the mobile device.

Furthermore, the present invention is capable of setting the small detection unit for detecting input operations made by the operator and to set the large input areas where the input operations are conducted on the mobile device main body. Thus, it is possible to present to the operator the input interface which can easily do an operation such as handwriting character input operations with scrolling actions requiring a large operation region and an operation that designates a start position of an input operation as an absolute position.

It is not limited to use only the living body fingers, for example, as the input areas. Artificial hands and the like may also be used. Further, the touching-side finger may also be an object such as a stick or a pen, for example.

Further, with the present invention, the physical amount for being transmitted through the finger is not limited only to the vibration but may also be light, electric signals, or the like, since it only needs to have the transmission system and the physical amount transmitting therethrough to make it possible to detect the input position based on a change generated in the transmission function of the transmission system when another object touches a prescribed position on the transmission system.

### Second Embodiment

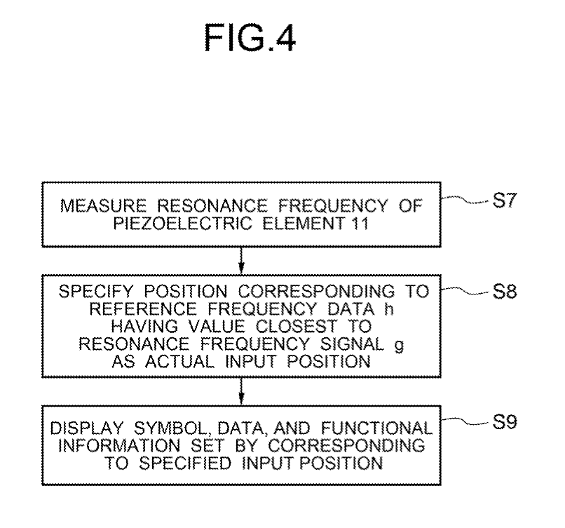

Next, an information input system of a second exemplary embodiment according to the present invention will be described by referring to FIG. 4. Note here that the same reference numerals are applied to the structural components that are the same as those of the first exemplary embodiment.

As shown in FIG. 4, as in the case of the first exemplary embodiment described above, the second exemplary embodiment is an information input system in a casing 10 as a mobile device main body unit such as a mobile phone, a PDA, or a notebook PC, and the information input system includes: a piezoelectric element 11 which generates a vibration; a resonance frequency measuring module 12 connected to the piezoelectric element 11, which measures the resonance frequency of the piezoelectric element 11 and outputs it as a resonance frequency signal g; a second database 13 which accumulates a plurality of pieces of reference frequency data h which correspond to a plurality of input positions, respectively; a second input information specifying module 14 which receives the resonance frequency signal g and the plurality of pieces of reference frequency data h, specifies the input position corresponding to the reference frequency data h having the value closest to the resonance frequency signal g as an actual input position, and outputs the position thereof as input information specifying data f; and an information presenting module 8 which receives the input information specifying data f, and displays prescribed symbol, data, functional information, and the like allotted to that position.

Further, while the input position is specified based on the change in the detected vibration generated due to the change in the vibration transmission properties of the thumb 100 and the forefinger 200 of the operator in the first exemplary embodiment, the input position (information) is specified based on a change in the resonance frequency of the vibration system that is caused by the change in the vibration transmission property of the vibration system including the piezoelectric element 11 as a vibrator and the thumb 100 touching thereto according to the positions on the thumb 100 touched by another finger 300.

Now, actions of the second exemplary embodiment will be described briefly.

First, the resonance frequency of the piezoelectric element 11 is measured and outputted as the resonance frequency signal g (step S7). Then, the resonance frequency signal g is compared with the plurality of pieces of reference frequency data h set in advance, specifies the input position corresponding to the reference frequency data h having the value closest to the resonance frequency signal g as an actual input position, and outputs that position as the input information specifying data (step S8). Prescribed symbol, data, functional information, and the like corresponding to the input information specifying data f are displayed (step S9).

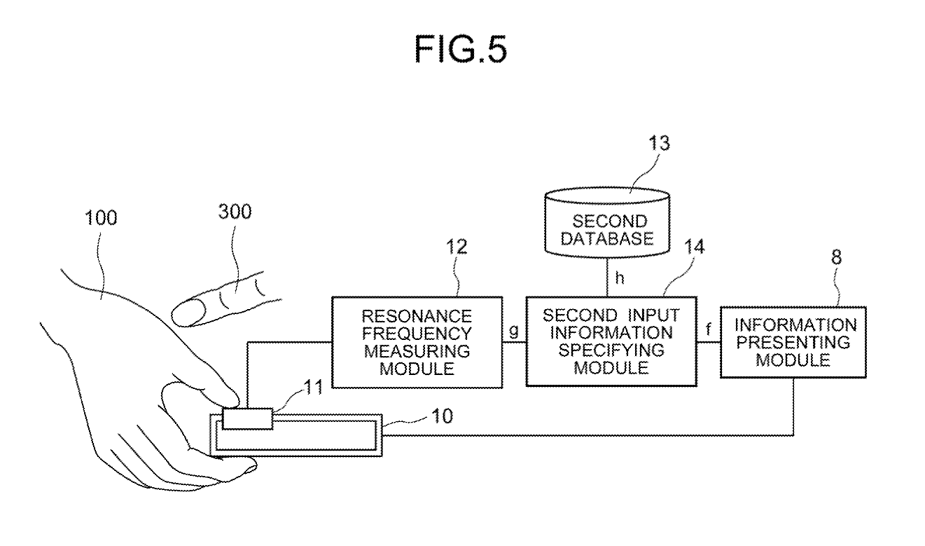

Next, actions of the information input system according to the second exemplary embodiment will be described in details based on a flowchart shown in FIG. 5. First, the resonance frequency measuring module 12 measures the resonance frequency of the piezoelectric element 11 while generating a vibration to the piezoelectric element 11, and outputs it as the resonance frequency signal g (step S7). Note here that typical electrical measuring methods such as an impedance measuring method and a kinetic admittance measuring method can be used for measuring the resonance frequency.

At this time, the resonance frequency of the piezoelectric element 11 changes depending on the mass, shape, and the like of the object that makes a contact with the piezoelectric element 11. That is, the measured resonance frequency changes depending on the touch of the thumb 100 on the piezoelectric element 11 and, further, the position where another finger 300 touches the thumb 100.

Therefore, it is possible to specify which position on the thumb 100 another finger 300 has touched by recognizing (detecting) the difference in the resonance frequencies. Thus, in the second exemplary embodiment, the second input information specifying module 14 compares the resonance frequency signal g with the reference frequency data h corresponded to the plurality of input positions recorded in the second database 13 in advance, specifies the input position corresponding to the reference frequency data h having the value closest to the resonance frequency signal g as the actual input position, and outputs the position thereof as the input information specifying data f (step S8).

The reference frequency data h is a pre-recorded data of the resonance frequencies of the piezoelectric element 11 in a case where three contact positions, for example, are set on the thumb 100 and another finger 300 actually touches each of the positions. The actual contact position can be specified by comparing and detecting which of the plurality of pieces of reference frequency data h the measured resonance frequency signal g is closest.

At last, prescribed symbol, data, and function allotted to the specified position are displayed on the information presenting module 8 (step S9), and the input operation is completed thereby.

As described above, this exemplary embodiment makes it possible to set the detection unit (the piezoelectric element 11) of the mobile device main body for detecting input operations made by the operator still smaller than the case of the first exemplary embodiment described above. Therefore, the display unit such as the display of the mobile device main body can be set still larger.

Further, with the first and second exemplary embodiments, the operator oneself can sense that there is an input operation made on the mobile device through a contact made on the body. Therefore, the operator can check which position the input is being made without looking at the operation part. As a result, input errors can be reduced.

While the present invention has been described by referring to the embodiments (and examples), the present invention is not limited only to those embodiments (and examples) described above. Various kinds of modifications that occur to those skilled in the art can be applied to the structures and details of the present invention within the scope of the present invention.

This Application claims the Priority right based on Japanese Patent Application No. 2008-222931 filed on Aug. 29, 2008 and the disclosure thereof is hereby incorporated by reference in its entirety.

### INDUSTRIAL APPLICABILITY

The present invention can be applied to small mobile devices such as mobile phones, PDAs, and notebook PCs. Particularly, the present invention can be effectively applied to a mobile device whose input unit on the device is set small among the portability-oriented small mobile devices.

### REFERENCE NUMERALS

1 Vibration element (physical amount applying module)
2 Vibration sensor (transmitted physical amount measuring module)
3 White noise generation module (physical amount applying module)
4 FFT module
5 First database
6 Correlation value calculation module
7 First input information specifying module (contact position specifying module)
8 Information presenting module
10 Casing
11 Piezoelectric element
12 Resonance frequency measuring module
13 Second database (reference frequency storage module)
14 Second input information specifying module (contact position specifying module)
100 Thumb of operator
101 First area
102 Second area
103 Third area
200 Forefinger (object) of operator
300 Another finger (object) of operator that touches thumb
a Drive signal
b Vibration detection signal
c Frequency axis signal
d Reference waveform data
e Correlation value data
f Input information specifying data
g Resonance frequency signal
h Reference frequency data

1. An information input system, comprising:
a physical amount applying module which applies a specific physical amount to a signal transmitting object;
a transmitted physical amount measuring module which measures the physical amount transmitted via the object; and
a contact position specifying module which detects a change in a transmission property generated when another object touches a transmission system of the physical amount formed by including the object, wherein
the contact position specifying module specifies a contact position of the object based on, a measurement signal of the physical amount transformed by corresponding to the change in the transmission property, and outputs positional information of the specified contact position.

2. The information input system as claimed in claim 1, wherein
the physical amount is a vibration, and the contact position specifying module specifies the contact position of another object mentioned above based on a change generated in a transmitted vibration waveform due to a change in a vibration transmission function of the object.

3. The information input system as claimed in claim 1, wherein
the physical amount is a vibration, and the contact position specifying module specifies the contact position of another object mentioned above based on a change generated in a resonance frequency of the transmission system including the object and a vibration source due to a change in a vibration transmission function of the object.

4. The information input system as claimed in claim 3, wherein:
the contact position specifying module comprises a reference frequency storage module which stores reference frequencies that are set in advance by corresponding to different positions on the object; and
the contact position specifying module specifies the contact position of another object mentioned above by comparing the change generated in the resonance frequency of the transmission system with the reference frequency.

5. An information input method, comprising:
applying a specific physical amount to a signal transmitting object;
measuring the physical amount transmitted via the object;
specifying a contact position of another object based on a change generated in a transmission property of a transmission system generated when another object mentioned above touches the transmission system of the physical amount formed by including the object; and
outputting the specified contact position of another object mentioned above as positional information.

6. A non-transitory computer readable recording medium storing an information input program for applying a specific physical amount to a signal transmitting object, measuring the physical amount transmitted via the object, and outputting information specified based on a change in a result of the measurement, the program causing a computer set in advance to execute: a contact position specifying function which detects a change in a transmission property generated when another object touches a transmission system of the physical amount formed by including the object, and specifies a contact position of another object mentioned above based on a measurement signal of the physical amount that changes in accordance with the detected change.

7. An information input system, comprising:
physical amount applying means for applying a specific physical amount to a signal transmitting object;
transmitted physical amount measuring means for measuring the physical amount transmitted via the object; and
contact position specifying means for detecting a change in a transmission property generated when another object touches a transmission system of the physical amount formed by including the object, wherein
the contact position specifying means specifies a contact position of the object based on a measurement signal of the physical amount transformed by corresponding to the change in the transmission property, and outputs positional information of the specified contact position.
